(19) United States
(12) Patent Application Publication
(10) Pub. No.: US 2009/0090064 A1
(43) Pub. Date: Apr. 9, 2009

(54) LIFTER PLATE WITH ENERGY ABSORPTION MEMBERS

(76) Inventors: Spiridon-Sorin S. Tudora, Richmond Hill (CA); Hung Chi Vong, Mississauga (CA); Miroslav Janda, Toronto (CA); James P. O'Halloran, Barrie (CA)

Correspondence Address: MAGNA INTERNATIONAL, INC., 337 MAGNA DRIVE, AURORA, ON, L4G-7K1, CA

(21) Appl. No.: 12/248,400

(22) Filed: Oct. 9, 2008

Related U.S. Application Data
(60) Provisional application No. 60/978,450, filed on Oct. 9, 2007.

(51) Int. Cl. E05F 11/38; B60J 5/04

(52) U.S. Cl. 49/348; 49/502

(57) ABSTRACT

In an embodiment, the invention is directed to a lifter plate for a vehicle window. The lifter plate includes a lifter plate body, a window holding portion, and an energy absorption member positioned to at least indirectly engage one vehicle window surface of the group consisting of a forward-facing surface and a rearward-facing surface.

This application claims the benefits of U.S. Provisional Application No. 60/978,450, filed Oct. 9, 2007.

### FIELD OF THE INVENTION

The present invention relates to lifter plates for holding vehicle windows, and more particularly to a lifter plate for a vehicle window that incurs fore/aft forces, such as the window on a sliding door of a minivan.

### BACKGROUND OF THE INVENTION

A door window in a vehicle is typically held by one or more lifter plates within the door assembly. Lifter plates are typically used in doors that are hinged to the frame of the vehicle, such as the front and rear doors of a typical sedan. More recently, manufacturers have incorporated mechanisms to raise and lower the windows on the sliding doors of minivans for the benefit of second and third row passengers in those vehicles. The stresses that are incurred by the lifter plates and the vehicle windows in those applications, however, are different than the stresses incurred in a typical application in a forward-hinged vehicle door. As a result, if typical lifter plates are used to hold the windows in such applications, the lifter plates and/or the vehicle windows can be prone to premature failure.

It would be advantageous to provide a lifter plate that, in use, manages the forces involved in an application with the fore/aft stresses associated with the opening and closing of a sliding vehicle door.

### SUMMARY OF THE INVENTION

In a first aspect, the invention is directed to a lifter plate for a vehicle window. The lifter plate includes a lifter plate body, a window holding portion, and an energy absorption member positioned to at least indirectly engage one vehicle window surface of the group consisting of a forward-facing surface and a rearward-facing surface.

In a second aspect, the invention is directed to a lifter plate for a vehicle window, wherein the lifter plate incorporates an energy absorption member is covered by a protective cover and that is positioned to engage the vehicle window indirectly, through the protective cover.

In a particular embodiment of the second aspect, the lifter plate includes a lifter plate body, a window holding portion connected to the lifter plate body and positioned to hold the vehicle window, an energy absorption member positioned to indirectly engage the vehicle window, and a protective cover positioned to cover the energy absorption member and is sufficiently movable with the energy absorption member so that, in use, engagement between the vehicle window and the energy absorption member takes place through the protective cover.

In a third aspect, the invention is directed to a lifter plate for a vehicle window wherein the lifter plate has a forward surface engagement member for engaging a forward-facing surface on the vehicle window, and a rearward surface engagement member for engaging a rearward-facing surface on the vehicle window. The lifter plate is configured to transfer forces from one of the forward and rearward surface engagement members to the other.

In a particular embodiment of the third aspect, the lifter plate includes a lifter plate body, a window holding portion connected to the lifter plate body and positioned to hold the vehicle window, a forward surface engagement member positioned to limit forward travel of the vehicle window in use, wherein the forward surface engagement member extends outward from the lifter plate body, a rearward surface engagement member positioned to limit rearward travel of the vehicle window in use, wherein the forward surface engagement member extends outward from the lifter plate body, and an inner surface engagement member and an outer surface engagement member positioned between the forward surface engagement member and the rearward surface engagement member, and a bridge extending around and outer surface engagement members and connecting the forward surface engagement member and rearward surface engagement member to transfer forces therebetween.

### BRIEF DESCRIPTION OF THE DRAWINGS

The present invention will now be described by way of example only with reference to the attached drawings, in which:

FIG. 1 is a perspective view of a portion of a portion of a vehicle door including first and second lifter plates in accordance with an embodiment of the present invention;

FIG. 2 is a magnified side view of one of the lifter plates shown in FIG. 1;

FIG. 3 is another magnified side view from the other side of the lifter plate shown in FIG. 2;

FIG. 4 is a magnified sectional view through section 3-3 shown in FIG. 3; and

FIG. 5 is a magnified side view of the other lifter plate shown in FIG. 1.

### DETAILED DESCRIPTION OF THE DRAWINGS

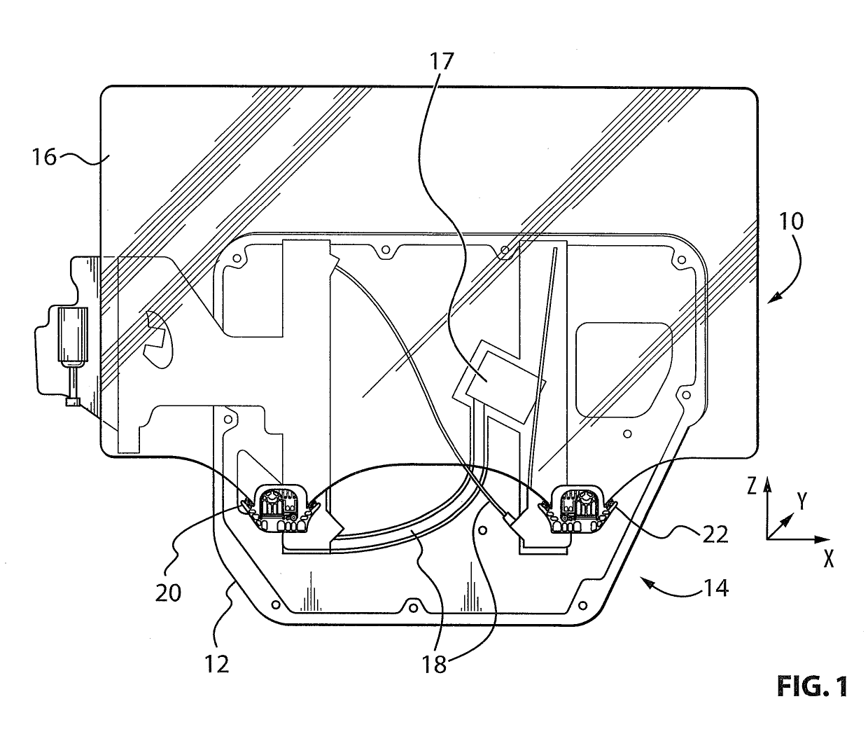

Reference is made to FIG. 1, which shows a portion of a vehicle door 10, including a carrier 12, a window regulator assembly 14 and a vehicle window 16. An axis system is shown to facilitate comprehension of certain terms used herein. The axis shown at ‘X’ represents the fore/aft direction in the vehicle. The axis shown at ‘Y’ represents the lateral direction in the vehicle (ie. the direction from side-to-side in the vehicle), and the axis ‘Z’ represents the vertical direction.

The carrier 12 holds, among other things, the window regulator assembly 14, thereby facilitating the mounting of the window regulator assembly 14 in the vehicle door 10.

The window regulator assembly 14 may include a drive motor 17, a set of drive cables 18, a first lifter plate 20, and a second lifter plate 22. The drive motor 17 is operatively connected to the first and second lifter plates 20 and 22 via the drive cables 18.

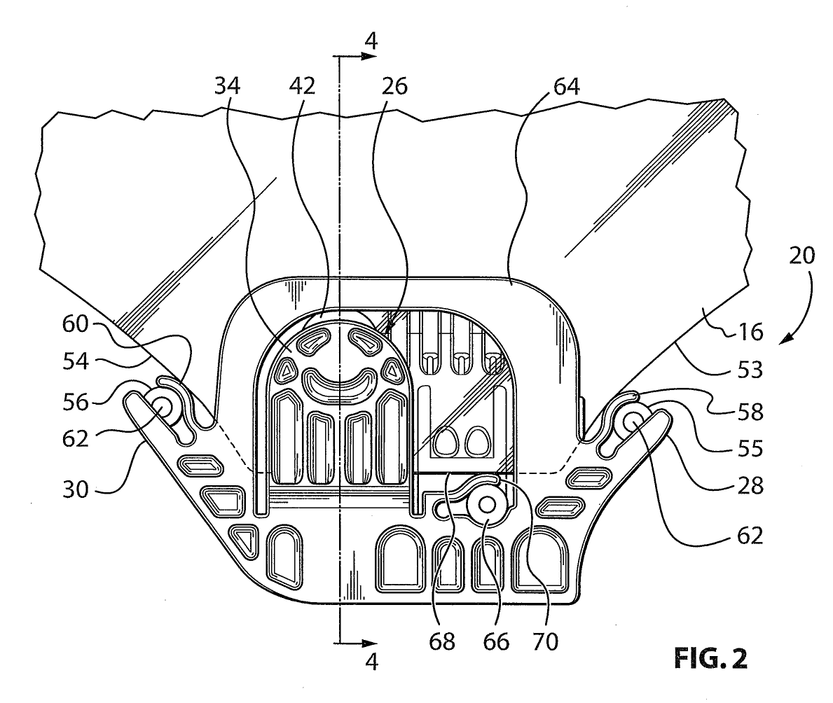

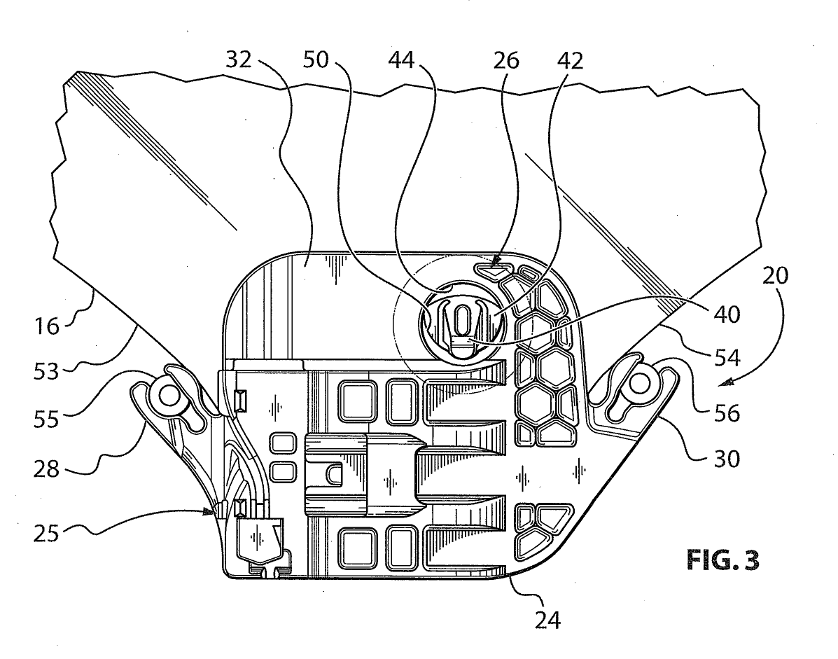

The first lifter plate 20 is shown in more detail in FIG. 2. The lifter plate 20 includes a lifter plate body 24, a cable mounting portion 25 (see FIG. 3), a window holding portion 26, a forward surface engagement member 28 and a rearward surface engagement member 30.

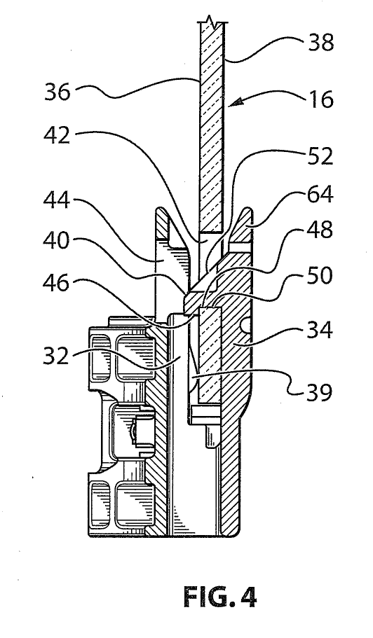

Referring to FIG. 4, the window holding portion 26 includes an inner surface engagement member 32 and an outer surface engagement member 34. The inner surface engagement member 32 may be generally planar and engages the inner surface, shown at 36, of the window 16. The outer surface engagement member 34 may be generally planar and engages the outer surface, shown at 38, of the vehicle window 16. The inner and outer surface engagement members 32 and 34 are spaced laterally from each other by a suitable amount to permit the introduction and positioning of the vehicle window 16 therebetween, and to provide a relatively snug fit with the vehicle window 16 so as to reduce the likelihood of noise in the form of BSR (buzz, squeak and rattle), during use of the window regulator assembly 14 and more generally during use of the vehicle. To further promote the snug fit with the vehicle window 16 a biasing member 39 is provided on the inner surface engagement members 32 which engages the window 16 may be biased to urge the vehicle window 16 against the outer surface engagement member 34.

A locking aperture engagement member 40 extends from the outer surface engagement member 34 through the window locking aperture, shown at 42, and at least partially through an inner surface engagement member aperture 44 on the inner surface engagement member 32. A shoulder 46 on the locking aperture engagement member 40 engages an upward-facing portion 48 of the edge, shown at 50, of the window locking aperture 42 to inhibit the vertical withdrawal of the window 16 from the lifter plate 20. A suitable lead-in surface 52 is provided on the locking aperture engagement member 40 at a suitable position to permit the vehicle window 16 to push the locking aperture engagement member 40 out of the way during insertion of the window 16 into the space between the inner and outer surface engagement members 32 and 34.

Referring to FIG. 2, the forward and rearward surface engagement members 28 and 30 are positioned to engage a forward-facing window surface 53 and a rearward-facing window surface 54 respectively, to limit forward and rearward travel respectively of the vehicle window 16. The forward and rearward-facing surfaces 53 and 54 do not have to be strictly forward- or rearward-facing (ie. strictly vertical). Instead they may extend at any angle that has a sufficient degree of forward- or rearward projection.

During opening and closing of the door 10 (FIG. 1), the vehicle window 16 may be subjected to relatively high forces in the fore/aft direction. Limiting the forward and rearward movement of the vehicle window 16 reduces the likelihood of a failure of the vehicle window 16 at the window locking aperture 42 (FIG. 3) due to shear between the window locking aperture 42 and the locking aperture engagement member 40.

In order to further reduce the likelihood of failure of the vehicle window 16 it is advantageous to control the acceleration and deceleration of the vehicle window 16 during opening and closing of the vehicle door 10, see FIG. 1, (and more particularly when the door 10 reaches the end of its travel either in the fully opened or fully closed positions). To assist in this regard, a forward energy absorption member 55 (FIG. 2) is preferably provided on the forward surface engagement member 28 and a rearward energy absorption member 56 is preferably provided on the rearward surface engagement member 30. When the vehicle door 10 decelerates abruptly, eg. at the end of its travel to the closed or open positions, the forward or rearward energy absorption member 55 or 56, as the case may be, is compressed by some amount by the vehicle window 16 thereby reducing the abruptness of the deceleration of the vehicle window 16.

The forward and rearward energy absorption members 55 and 56 may be made from any suitable material, such as Santoprene® from some other resilient polymeric material. Depending on the material selected, however, direct engagement with the vehicle window 16 could result in premature wear or failure of the forward and rearward energy absorption members 55 and 56.

In order to inhibit direct engagement of the vehicle window 16 and the forward and rearward energy absorption members 55 and 56, protective covers 58 and 60 may be provided to cover the forward and rearward energy absorption members 56 and 58. The protective covers 56 and 58 are sufficiently flexible so as to move with the energy absorption members 55 and 56 as the energy absorption members 55 and 56 compress, so that engagement between the vehicle window 16 and the energy absorption members 55 and 56 takes place indirectly, ie. through the protective cover 58 or 60.

Each of the energy absorption members 55 and 56 may have an energy absorption body 61 that is cylindrical in shape, and that may include an axially extending aperture shown at 62. The aperture 62 facilitates compression of the energy absorption member 55 or 56 during engagement with the vehicle window 16. The cylindrical shape of the energy absorption member 55 or 56 facilitates its manufacture, which can be achieved by cutting selected lengths of a cylindrical rod of suitable material.

During engagement with the vehicle window 16, the forward and rearward surface engagement members 28 and 30 may incur relatively high forces. For example, relatively high forces are incurred on the forward surface engagement member 28 during deceleration of the vehicle door 10 (FIG. 1) to its closed position, and as the door 10 travels along an arcuate path just prior to closure as is typical in minivan sliding door movement.

Referring to FIG. 2, since these members 28 and 30 extend out away from the lifter plate body 24, such forces can increase the likelihood of failure of these members 28 and 30 over time. To assist in strengthening the forward and rearward surface engagement members 28 and 30, means may be provided to distribute the load incurred at either of the forward and rearward surface engagement members 28 and 30 to elsewhere in the lifter plate 20. For example, an outer bridge 64 may be provided which extends around the outer surface engagement member 34 to connect the outer sides of the forward and rearward surface engagement members 28 and 30 to each other. The outer bridge 64 acts to distribute forces from whichever of the forward and rearward surface engagement members 28 and 30 is incurring the higher load, to the other side of the lifter plate 20 where loads are relatively lower, thereby strengthening the lifter plate 20. Additionally, the inner surface engagement member 32 (FIG. 3) may itself connect the inner sides of the forward and rearward surface engagement members 28 and 30 to each other to similar benefit as the outer bridge 64 (FIG. 2).

The bridge 64 is provided as a separate element from the outer surface engagement member 34 because of the degree of flexing that is required by the outer surface engagement member 34 during insertion of the window 16 into the lifter plate 20, due to the presence of the locking aperture engagement member 40 (FIG. 4) thereon. In an embodiment wherein the locking aperture engagement member 40 is provided on an inner surface engagement member 32 instead of being provided on the outer surface engagement member 34, the bridge 64 would consequently be provided on the inner sides of the forward and rearward surface engagement members 28 and 30, and on the other side would be an outer surface engagement member that is also a force transfer member between the forward and rearward surface engagement members 28 and 30.

It will be understood that the presence of the bridge 64 and the force transfer properties of the inner surface engagement member 32 are advantageous in the lifter plate 20 whether or not the energy absorption members 55 and 56 are provided. In other words, if the forward and rearward surface engagement members 28 and 30 are provided for limiting the forward and rearward movement of the vehicle window 16, then it is advantageous to provide the bridge 64 and the inner surface engagement member 32 with force transfer capability so that forces are distributed more evenly, thereby strengthening the lifter plate 20.

As shown in FIG. 2, a downward energy absorption member 66 may be provided, for engagement with a downward-facing surface 68 on the vehicle window 16. The downward energy absorption member 66 may be covered by a protective cover 70 so as to avoid direct engagement with the vehicle window 16, since direct engagement with the vehicle window 16 could result in mechanical damage to the downward energy absorption member 66. The protective cover 70 may be similar to the protective covers 58 and 60.

The vehicle window 16 may rest solely on the three energy absorption members 55, 56 and 66, so that compliance is provided regardless of the direction in which the vehicle window 16 is used. Additionally, the downward energy absorption member 66 may be used to urge the upwards-facing portion 48 of the edge 50 of the window locking aperture 42 against the shoulder 46 of the locking aperture engagement member 40, so as to reduce BSR during use of the window regulator assembly 14 and during use of the vehicle.

It will be appreciated that the presence of the protective cover 70 on the downward energy absorption member 66 is advantageous in a lifter plate irrespective of whether the lifter plate incorporates forward and rearward surface engagement members and irrespective of whether the lifter plate is used in an application where fore/aft forces are a concern.

In general, the protective covers 58, 60 and 70 may be made from any suitable material, such as the material of the lifter plate body, which may be Delrin, for example, or other durable polymeric materials.

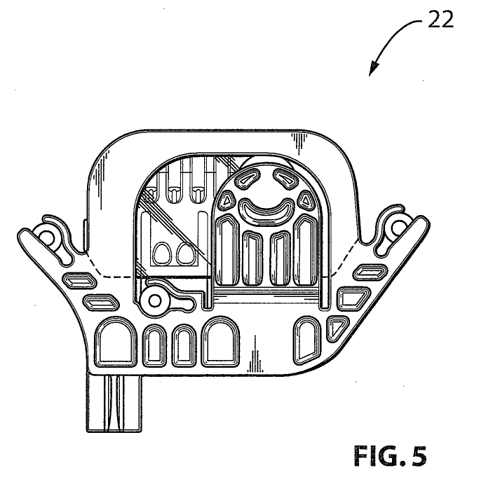

The second lifter plate 22 is shown in FIG. 5, and may be generally a mirror-image of the lifter plate 20, though some minor features may differ, such as the positioning and configuration of any connections to drive cables 18 or the like.

The vehicle window 16 has been shown in FIG. 1 to be made from a glass panel, having a suitably contoured lower edge. It is alternatively possible for the vehicle window 16 to be made from a combination of a glass panel, and one or two polymeric brackets mounted to the lower edge of the glass panel, such that the brackets connect to the lifter plates 20 and 22 from the window regulator assembly 14. The forward- and rearward-facing surfaces and the downward-facing surface referred to in the above description and appended claims would optionally all be present on each bracket that is mounted on the glass panel.

While the above description constitutes a plurality of embodiments of the present invention, it will be appreciated that the present invention is susceptible to further modification and change without departing from the fair meaning of the accompanying claims.

I claim:

1. A lifter plate for a vehicle window, comprising:
a lifter plate body;
a window holding portion connected to the lifter plate body and positioned to hold the vehicle window; and
an energy absorption member positioned to at least indirectly engage one vehicle window surface of the group consisting of a forward-facing surface and a rearward-facing surface.

2. A lifter plate as claimed in claim 1, further comprising a protective cover, wherein the protective cover is positioned to cover the energy absorption member and is sufficiently movable with the energy absorption member so that, in use, engagement between the vehicle window and the energy absorption member takes place through the protective cover.

3. A lifter plate as claimed in claim 1, wherein the energy absorption member is positioned to engage, a forward-facing surface of the vehicle window.

4. A lifter plate as claimed in claim 1, wherein the energy absorption member is positioned to engage a rearward-facing surface of the vehicle window.

5. A lifter plate as claimed in claim 1, wherein the energy absorption member is a forward energy absorption member and is positioned to engage the forward-facing surface, and wherein the lifter plate further comprises a rearward energy absorption member which is positioned to engage the rearward-facing surface.

6. A lifter plate as claimed in claim 5, further comprising a downward energy absorption member wherein the downward energy absorption member is positioned to engage a downward-facing surface of the vehicle window.

7. A lifter plate as claimed in claim 5, further comprising:
a forward surface engagement member that supports the forward energy absorption member;
a rearward surface engagement member that supports a rearward energy absorption member, wherein the forward and rearward surface engagement members extend outward from the lifter plate body; and
a bridge extending around an element of the lifter plate and connecting the forward and rearward surface engagement members to each other to transfer forces therebetween.

8. A lifter plate as claimed in claim 7, wherein the bridge is positioned on one side of the forward and rearward surface engagement member and wherein the lifter plate further includes a force transfer member connecting the other side of the forward and rearward surface engagement member to transfer forces therebetween.

9. A lifter plate as claimed in claim 1, wherein the energy absorption member has an energy absorption member body that is generally cylindrical.

10. A lifter plate as claimed in claim 9, wherein the energy absorption member body has a longitudinal axis, and has an aperture that extends along the longitudinal axis.

11. A lifter plate for a vehicle window, comprising:
a lifter plate body;
a window holding portion connected to the lifter plate body and positioned to hold the vehicle window;
an energy absorption member positioned to indirectly engage the vehicle window; and
a protective cover positioned to cover the energy absorption member and is sufficiently movable with the energy absorption member so that, in use, engagement between the vehicle window and the energy absorption member takes place through the protective cover.

12. A lifter plate for a vehicle window, comprising:
a lifter plate body;
a window holding portion connected to the lifter plate body and positioned to hold the vehicle window;
a forward surface engagement member positioned to limit forward travel of the vehicle window in use, wherein the forward surface engagement member extends outward from the lifter plate body;
a rearward surface engagement member positioned to limit rearward travel of the vehicle window in use, wherein the forward surface engagement member extends outward from the lifter plate body;
an inner surface engagement member and an outer surface engagement member positioned between the forward surface engagement member and the rearward surface engagement member; and
a bridge extending around one of the inner and outer surface engagement members and connecting the forward surface engagement member and rearward surface engagement member to transfer forces therebetween.

13. A lifter plate as claimed in claim 12, wherein the bridge is an inner bridge and connects an inner side of the forward surface engagement member and an inner side of the rearward surface engagement member and wherein the lifter plate further includes an outer bridge extending around the outer surface engagement member and connects an outer side of the forward surface engagement member and an outer side of the rearward surface engagement member to transfer forces therebetween.
